(19) United States
(12) Patent Application Publication
(10) Pub. No.: US 2003/0197659 A1
(43) Pub. Date: Oct. 23, 2003

(54) Image display apparatus and control method for image display apparatus

(75) Inventor: Yutaka Arai, Atsugi-shi (JP)

Correspondence Address: SCULLY SCOTT MURPHY & PRESSER, PC, 400 GARDEN CITY PLAZA, GARDEN CITY, NY, 11530

(73) Assignee: NEC-MITSUBISHI ELECTRIC VISUAL SYSTEMS CORPORATION, Tokyo (JP)

(21) Appl. No.: 10/414,963

(22) Filed: Apr. 16, 2003

(30) Foreign Application Priority Data
Apr. 19, 2002 (JP) 2002-117892

(51) Int. Cl. G09G 5/00

(52) U.S. Cl. 345/1.1

(57) ABSTRACT

An object is to reduce the time and trouble at the time of switching pages, by displaying two or more pages at the same time on one image display apparatus. A image signal generator 11 outputs a net of image signal, a synchronization signal corresponding to the net of image signals, and a transmission index signal substituted for one part of the net of image signals, and applies these in parallel to the image display apparatuses 13 and 14. In the case where a plurality of image display apparatus numbers are set for the image display apparatus 13, the image display apparatus numbers together with the locations where the signals for the respective image display apparatus numbers are displayed are set. In an image display apparatus for which the image display apparatus number and the transmission index signal are compatible, the net image signal contained in the frame having the image display apparatus number from the image signal side is compressed so that the image signal can be displayed relative to the number of the image display apparatuses which numbers are set, and is displayed on the image display section of the appropriate image display apparatus 13.

### BACKGROUND OF THE INVENTION

1. Field of the Invention

The present invention relates to an image display apparatus and a control method for an image display apparatus, for receiving from a image signal generator, a image signal having a predetermined format used for example in a personal computer (hereunder referred to as a PC), and displaying the image signal on a display device such as a liquid crystal, a CRT, a plasma display (PDP) or an electroluminescence (EL) display.

2. Description of the Related Art

FIG. 15 is a block diagram of an image display system disclosed in Japanese Unexamined Patent Application, First Publication No. 2000-352962, comprising a image signal generator and an image display apparatus for the case where indexing is used. In FIG. 15, this image display system comprises a image signal generator 151, a plurality of image display apparatuses 152, and a image signal generating device 153. Furthermore, FIG. 16 and FIG. 17 are diagrams showing the relationship between a image signal and an index in the above mentioned image display system disclosed in Japanese Unexamined Patent Application, First Publication No. 2000-352962.

Next is a description of the operation of the image display system shown in FIG. 15. As shown in FIG. 15, in the proposal of Japanese Unexamined Patent Application, First Publication No. 2000-352962, with respect to the image signal generator 151 including one image signal generating device 153, a plurality of image display apparatuses 152 can be connected in parallel by means of a connection cable or the like, so that different images can be displayed on each of the image display apparatuses 152. More specifically, the image signal generator 151 has a plurality of pages thereinside, and the image signal generating device 153 generates a composite signal containing index signals allotted to each of the pages as per the relationship diagram of image signals and indexes shown in FIG. 16, and the image display apparatuses 152 judge from these index signals whether or not the signal is for their own apparatus to perform display. This composite signal is divided timewise for each page as shown in FIG. 17 and transmitted. Moreover, each of the image display apparatuses 152 have a display device number differing respectively by 1 so that different displays can be performed for each of the image display apparatuses 152.

Furthermore, in the technique of the disclosure of Japanese Unexamined Patent Application, First Publication No. 2000-352962, it is also possible as with the system concept diagram for the image display apparatus shown in FIG. 18, to have a construction where a plurality of image display apparatuses 152 are series connected to one image signal generator 151. In this case, the image display apparatuses 152 can display different images. More specifically, in contrast to the image display apparatuses 152 shown in FIG. 15 connected in parallel, in the image display apparatuses 152 shown in FIG. 18, by providing image output devices inside each of these, these can display images one by one, while sequentially transmitting the received image signals to the next stage image display apparatus. At this time, by setting different image display apparatus numbers for each of the image display apparatuses 152, different images can be displayed on the respective image display apparatuses 152.

In the parallel connected image display apparatuses 152 shown in FIG. 15 and the series connected image display apparatuses 152 shown in FIG. 18, the image display apparatuses 152 each have a unique image display apparatus number, so that different image displays can be performed for each of the image display apparatuses 152. However, since each of the image display apparatuses 152 can only display one picture at the same time, then in the case where the image signal generator 151 has more pages than the number of actual image display apparatuses 152, when a reference page is selected, there is a deterioration in user friendliness in that a switching operation must be performed for times relative to the number of pages. Furthermore, with usage such as where a plurality of image display apparatuses 152 are used by a large number of people, then also in the case of referring to a screen which is being viewed by a user other than oneself, possibly there is annoyance such as that a switching operation is necessary for times relative to the numbers of pages.

The present invention addresses the above mentioned problems, with the object of providing an image display apparatus which can reduce the time and trouble at the time of switching pages, by displaying two or more pages at the same time on one image display apparatus, and of providing a control method for an image display applicable to respective image display apparatuses.

### SUMMARY OF THE INVENTION

In order to achieve the above mentioned objects, an image display apparatus of the present invention is one where an image display apparatus for receiving a image signal having a predetermined format and displaying the received image signal, comprises: a image signal receiving section which receives a composite signal containing a image signal comprising a plurality of image frames, a synchronization signal corresponding to this image signal, and a transmission index signal substituted for one part of the image signal, and outputs the image signal and the synchronization signal; an image frame selection section which multiply selects image frames to be displayed on its own device from the plurality of image frames, based on the transmission index signal output from the image signal receiving section, and simultaneously outputs a plurality of image signals corresponding to the selected plurality of image frames; and an image display section which displays a image signal corresponding to the plurality of image frames output from the image frame selection section.

Moreover, in the image display apparatus of the present invention, the image frame selection section comprises: an index discriminating device which discriminates a transmission index signal contained in either of an image display period and an image non-display period in an image frame, based on the image signal and the synchronization signal output from the image signal receiving section; an image display apparatus number/position setting device which outputs a plurality of image display apparatus numbers set with respect to its own device, and image display positions corresponding to these; an index judgment device which outputs a frame selection signal for selecting an image frame contained in a image signal, based on an index signal output by the index discriminating device and an image display apparatus number of its own device output by the image display apparatus number/position setting device; a frame selection device which selects an image frame contained in the image signal corresponding to a frame selection signal output from the index judgment device; an image compression device which compresses a image signal corresponding to an image frame output from the frame selection device, based on a set image display apparatus number; and an image storage device which stores a compressed image signal output from the image compression device in accordance with an image display position output by the image display/position apparatus number setting device.

Furthermore, in the image display apparatus of the present invention, the image frame selection section further comprises a clearing device which clears information stored in the image storage device.

Moreover, in the image display apparatus of the present invention, the image frame selection section further comprises a communication device which communicatively connects the image display apparatus number/position setting device and the image storage device.

Furthermore, a control method for an image display apparatus according to the present invention for receiving a image signal having a predetermined format and displaying the received image signal on an image display apparatus, comprises the steps of; controlling the image display apparatus number and image display position based on a control signal contained in a transmission index signal, and displaying a desired image on the image display apparatus.

According to the present invention, the image display apparatus can select an arbitrary frame from the received image signal and display this at an arbitrary image display position. At this time, a plurality of pictures which differ depending on the number of settings of the image display apparatus number can be displayed on one image display apparatus.

Moreover, display of an abnormal screen due to an irregular signal over the period from after starting power supply until receiving a transmission index signal to be displayed can be prevented. Furthermore, also in the case where a user wants to delete a display screen, it is possible to delete just a specific page. Moreover, by displaying a specific pattern accompanying clearing of the screen to show it has been cleared, it can be easily discriminated if there is a null signal or a clear screen. By means of such an operation, it is possible to avoid displaying an image which may be disagreeable to the user. Moreover, since selection of display/non display of an image can be performed, depending on the content of an applied scene, it is possible to provide an image display apparatus which can give high usage with an even greater degree of freedom to the user.

Furthermore, since it is no longer necessary for the user to set the image display apparatus number each time the display apparatus is used, then convenience is improved, and deterioration in working efficiency due to erroneous setting such as when setting the number of pages can be avoided. Moreover, in the case where the image display apparatuses are connected sequentially in series, then by setting the image display apparatus numbers using the communication device, series connection of the image display apparatus can be easily performed. In this case, since it is no longer necessary to perform connection setting using the image signal generator, the configuration of the image display system is simplified.

Moreover, by connecting the communication device and the image storage device, the timing for clearing the image can be set from the image signal generator. As a result, it becomes possible to ensure that abnormal signals generated for example when the image signal is changed, are not displayed. Hence an image display apparatus which does not give discomfort to the user can be provided.

Moreover, by using a non volatile memory for the image storage device, then if the user once displays different images on each of a plurality of image display apparatuses, the image can be displayed by the image display apparatus even if subsequently, the image signal generator disappears. As a result, a highly convenient image display apparatus can be provided for cases where this is used for a store front display or the like.

Furthermore, communication from the image signal generator to the image display apparatus can be realized even if a communication device is not separately provided. Consequently, the image display apparatus number and the image display position can be controlled by communication. Therefore operations such as automatically changing a setting for a desired image are possible without the user changing the setting for the image display apparatus itself.

### BRIEF DESCRIPTION OF THE DRAWINGS

FIG. 1 is a block diagram schematically showing an image display system according to a first embodiment of the present invention.

FIG. 2 is a block diagram showing a configuration of an image display apparatus according to the first embodiment of the present invention.

FIG. 3 is a timing chart showing a relationship between image signal and index in the first embodiment of the present invention.

FIG. 4 is a timing chart showing a relationship between image signal and index in the case of a plurality of pages in the first embodiment of the present invention.

FIG. 5 is an explanatory diagram showing a specific example of a transmission index signal substituted for one part of a image signal, in the first embodiment of the present invention.

FIG. 6 is a conceptual diagram showing an image display apparatus for the case where two numbers are set for the image display apparatus number, in the first embodiment of the present invention.

FIG. 7 is a conceptual diagram showing an image display apparatus for the case where four numbers are set for the image display apparatus number, in the first embodiment of the present invention.

FIG. 8 is a diagram showing a relationship between the index ID indicated by a flag and the image display apparatus number for selecting a frame, in the first embodiment of the present invention.

FIG. 9 is a block diagram showing a configuration of an image storage device in the first embodiment of the present invention.

FIG. 10 is a block diagram showing a configuration of an image storage device in a second embodiment of the present invention.

FIG. 11 is a block diagram showing a configuration of an image storage device in the case where pattern information is written in, in the second embodiment of the present invention.

FIG. 12 is a block diagram showing a configuration of an image display apparatus in a third embodiment of the present invention.

FIG. 13 is a conceptual diagram showing flags for one part of one line of a image signal in the case where a transmission index signal is substituted for one part of a image signal, in a fifth embodiment of the present invention.

FIG. 14 is a block diagram showing a configuration of an image display apparatus according to the fifth embodiment of the present invention.

FIG. 15 is a block diagram showing a image signal generator and an image display apparatus according to a convention example.

FIG. 16 is a timing chart showing image signal and index according to the conventional example.

FIG. 17 is a timing chart showing image signal and index according to the conventional example.

FIG. 18 is a conceptual diagram showing a image signal generator and image display apparatuses according to the conventional example.

### DESCRIPTION OF THE PREFERRED EMBODIMENTS

Hereunder is a detailed description of several embodiments of an image display apparatus according to the present invention, with reference to the drawings.

First Embodiment

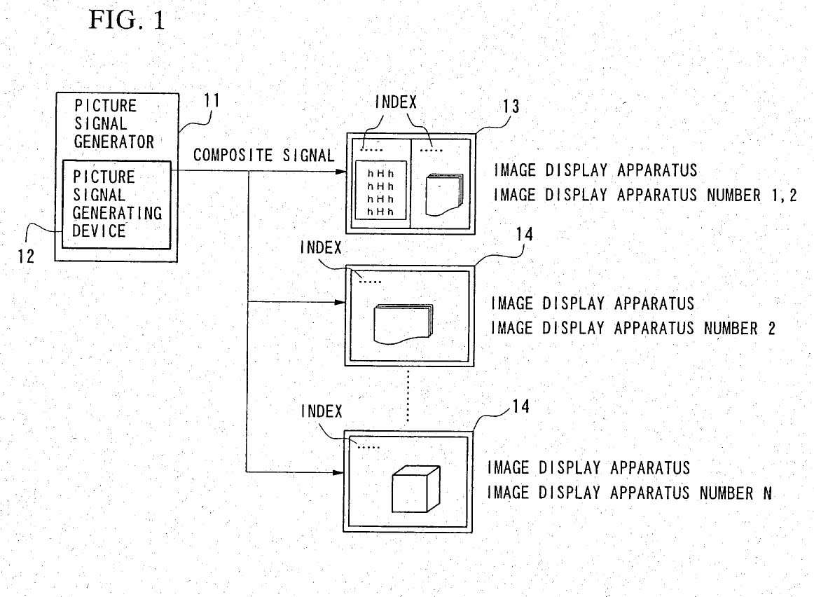

FIG. 1 is a block diagram schematically showing an image display system according to a first embodiment of the present invention. In FIG. 1, this image display system comprises; a image signal generator 11, a image signal generating device 12, and a plurality of image display apparatuses 13 and 14. Here, as shown in the figure, the plurality of image display apparatuses 13 and 14 have (are set with) one or a plurality of image display apparatus numbers 1-N and are shown connected electrically to the image signal generator 11 by for example a connection cable or the like.

Hereunder is a description of, the operation of the image display system. The image signal generator 11 outputs a net image signal which is to be actually displayed in an image display section (for example a liquid crystal panel, a CRT, a PDP, an EL, etc.) which is arranged in the image display apparatuses 13 and 14, a synchronization signal corresponding to this net image signal, and a transmission index signal substituted for one part of the net image signal (hereunder these output signals are generally referred to as a composite signal). In this composite signal, most basically, an original frame is constructed from the net image signal and the synchronization signal, but a frame containing a transmission index signal (also referred to as an image frame) is further constructed in this original frame. However, in the description of the embodiment described hereunder there is also the case where the frame described here does not contain a transmission index signal.

Moreover, regarding the image display apparatus number from the image signal side, the net image signal in the frame constituting the composite signal, is for specifying whether or not to display by means of the image display apparatus having the image display apparatus number of any of the plurality of image display apparatuses 13 and 14 as shown in FIG. 1. Proceeding with the explanation, apart from specifying the image display apparatuses 13 and 14, comment is also given on the transmission index signal for the case where various information is appended. A proviso is that at least information related to the image display apparatus number is included.

The composite signal output from the image signal generator 11 is applied in parallel to the respective image display apparatuses 13 and 14. In other words, composite signals having the same contents are respectively applied to the image display apparatuses 13 and 14. In each of the image display apparatuses 13 and 14, basically, the respective signals of the net image signal, the synchronization signal and the transmission index signal are separated from the received composite signal. Then, in the case where only one number is set for the image display apparatus number as with the image display apparatus 14, then in the image display apparatus for which the set image display apparatus number and the transmission index signal are compatible, the net image signal contained in the frame having the image display apparatus number from this image signal side is displayed on the image display section of the image display apparatus 14.

In the case where a plurality of image display apparatus numbers are set as with the image display apparatus 13, the image display apparatus numbers together with the locations where the signals for the respective image display apparatus numbers are displayed are set. Here, in the image display apparatus for which the image display apparatus number and the transmission index signal are compatible, the net image signal contained in the frame having the image display apparatus number from this image signal side is compressed so that only a small part of the set image display apparatus number can be displayed, and this is displayed on the image display section of the image display apparatus 13.

In the above described example, the image display apparatus number set in the image display apparatuses 13 and 14 may exist in duplicate. In this case, then naturally there will be the same display in the image display apparatuses set with the same image display apparatus number. In the case where the transmission index signal is substituted in the net image signal and output from the image signal generator 11, then within the display image in the image display apparatuses 13 and 14, the display content shown as the index such as shown in FIG. 1 is displayed together with the display content in the net image signal. In the same manner as described above, by simply including the transmission index signal in the image signal of the existing format, then an arbitrary page can be displayed on an arbitrary image display apparatus.

Furthermore, regarding above described display method, for the image display apparatus 14 having only one image display apparatus number, this is described in detail in the disclosure of Japanese Unexamined Patent Application, First Publication No. 2000-352962. Consequently, in this embodiment of the invention, particularly for the image display apparatus 13 having two or more image display apparatus numbers, a description is given for the control method for an image display apparatus, from reception of the image signal up until display of the image signal.

A control method from reception of a image signal of the image display apparatus 13 having two or more image display apparatus numbers up until display of the image signal is as follows. That is to say, in a first step, a composite signal containing a transmission index signal substituted for one part of the image signal in an arbitrary image frame of a image signal comprising a plurality of image frames is received. Next, in a second step, an image frame which is to be displayed on its own device is selected from a plurality of image frames, based on the transmission index signal contained in the received composite signal, and the image signal corresponding to the selected image frame is stored.

In the second step, while described in detail later, there is included respective steps from (a) to (d) as described hereunder. At first, (a) the transmission index signal is discriminated from the composite signal and an index signal is output. (b) a frame selection signal is output based on the output index signal and an image display apparatus number set for its own device. (c) the image frame contained in the image signal corresponding to the output frame selection signal is selected. (d) the image signal containing the selected image frame is compressed corresponds to the number of the set image display apparatuses numbers and is stored.

Then, after storing the image signal corresponding to the selected image frame in the second step, in the third step, a image signal corresponding to the output image frame is displayed by means of the image display section.

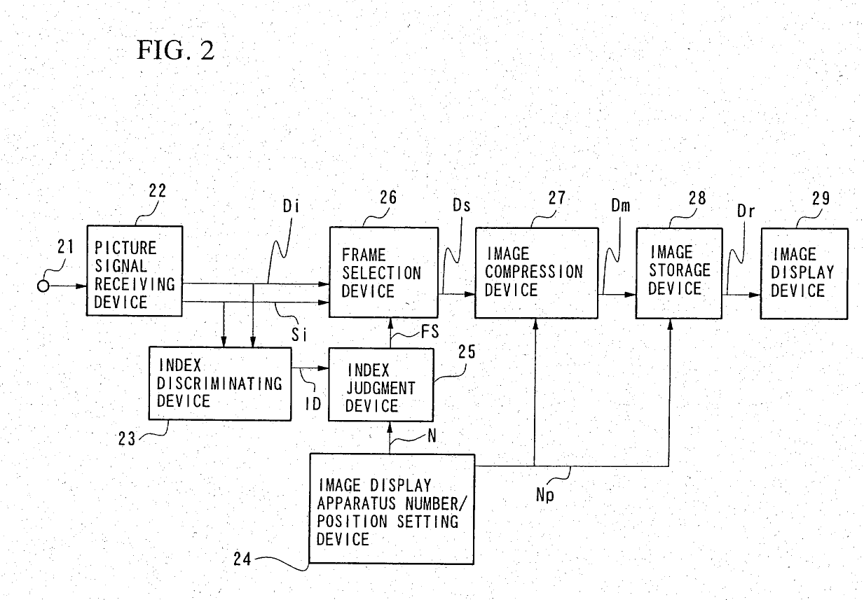

Hereunder is a more detailed description of the first embodiment with reference to the drawings. FIG. 2 is block diagram showing the internal structure of the image display apparatus shown in FIG. 1. As shown in FIG. 2, the image display apparatus comprises; a image signal input terminal 21, a image signal receiving device 22, an index discriminating device 23, an image display apparatus number/position setting device 24, an index judgment device 25, a frame selection device 26, an image compression device 27, an image storage device 28, and an image display device 29.

Moreover, Di is a image signal output from the image signal receiving device 22, Ds is a image signal which the frame selection device 26 outputs, Dm is a image signal which the image compression device 27 outputs, Dr is a image signal which the image storage device 28 outputs, Si is a synchronization signal which the image signal receiving device 22 outputs, ID is an index which is discriminated by the index discriminating device 23, N is an image display apparatus number set by the image display apparatus number/position setting device 24, FS is a frame selection signal which the index judgment device 25 outputs, and Np is an image display position set by the image display apparatus number/position setting device 24.

Here in the description of the various embodiments hereunder, while not particularly limiting, the image signal receiving device 22 constitutes the image signal receiving section, the index discriminating device 23, the image display apparatus number/position setting device 24, the index judgment device 25, the frame selection device 26, the image compression device 27, and the image storage device 28 constitute the image frame selection section, and the image display device 29 constitutes the image display section.

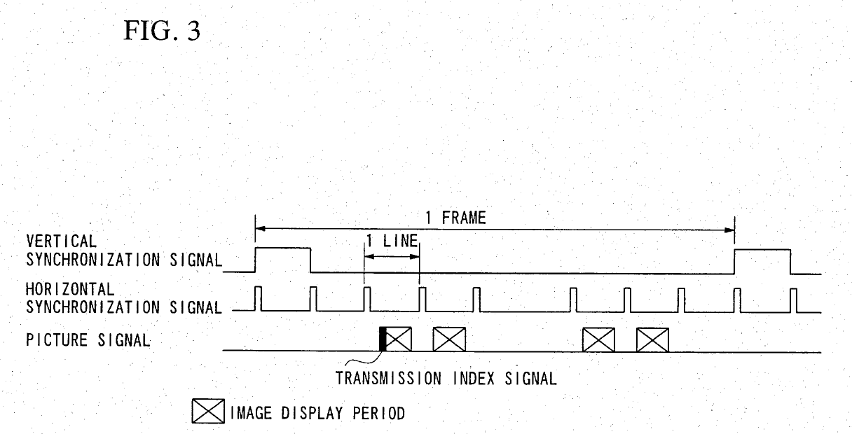

Next is a description of the operation of the image display apparatus shown in FIG. 1 and FIG. 2. Here the image signal receiving section (image signal receiving device 22) and the image display section (image display device 29) are the same as those disclosed in Japanese Unexamined Patent Application, First Publication No. 2000-352962, and hence description is omitted hereunder. FIG. 3 is a relationship diagram of the image signal and the transmission index signal, for explaining the case where the transmission index signal is substituted for one part of the image signal in the image display period within the image signal. The horizontal axis represents time and the vertical axis represents voltage. As will be understood by referring to FIG. 3, the relationship of the respective timings of the vertical synchronization signal, the horizontal synchronization signal and the image signal in a single frame period is shown.

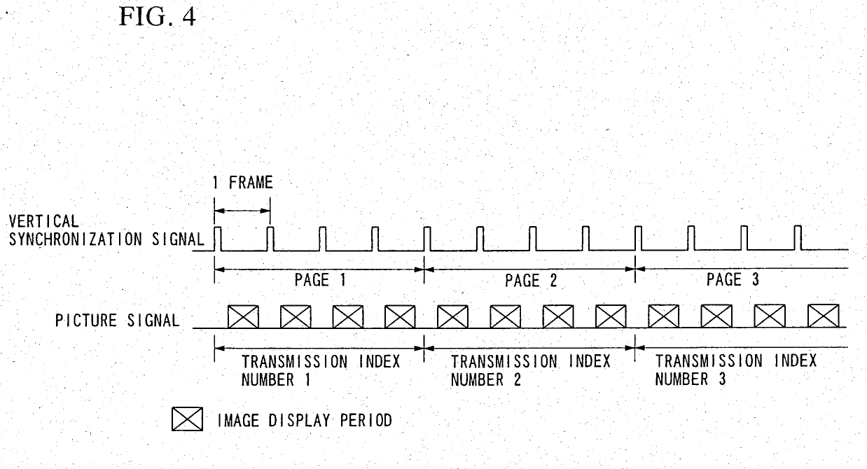

FIG. 4 is a relationship diagram of the image signal and the transmission index signal, for explaining a relationship of the timing of a image signal of a plurality of pages and a transmission index signal substituted for one part of the image signal, which the image signal generating device 12 shown in FIG. 1 outputs. In FIG. 4, the horizontal axis represents time and the vertical axis represents voltage. Moreover, page referred to here, as will be understood with reference to FIG. 4, is a page comprising one or more timewise consecutive frames. Furthermore, the definition of page includes the meaning of one section (that is a section where one display screen is constituted by one or a plurality of regions) for the case where one display screen is divided into one or a plurality of regions, or one type of display screen in a plurality of types of display screens for which the contents are basically each different in different pages.

In FIG. 4, to simplify understanding, the transmission index signal corresponding to page 1 corresponds to index 1, the transmission index signal corresponding to page 2 corresponds to index 2, and the transmission index signal corresponding to page 3 corresponds to index 3. Here, the image signal generator 11 switches over the page after the one frame where the transmission index signal is changed as shown in the figure.

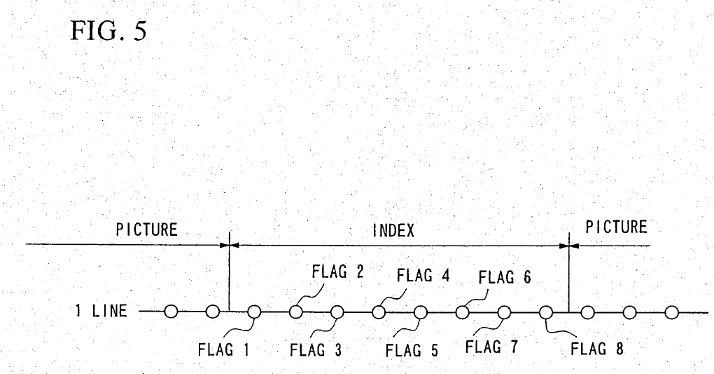

FIG. 5 is an explanatory diagram for explaining a specific example of a transmission index signal substituted for one part of the image signal, in the image signal generator 11, and shows one part of one line in the image signal corresponding to one line on the display image. In FIG. 5, the circle flags represent one pixel. The transmission index signal comprises for example 8 pixels at predetermined positions (here on one line on the display screen) of an image period. A desired lighting (brightness) is set for the respective pixels which constitute the transmission index signal. Based on this lighting (brightness), as described later, a flag is generated corresponding to the image display apparatus number.

Hereunder is a description of the operation with reference to the drawings. As shown in FIG. 1 and FIG. 2, the composite signal input to the image signal input terminal 21 of the image display apparatuses 13 and 14 is received by the image signal receiving device 22. The image signal receiving device 22, as described in Japanese Unexamined Patent Application, First Publication No. 2000-352962, outputs a synchronization signal Si and a image signal Di which has been digitized. In this case, the transmission index is substituted within the image signal Di and digitized.

The synchronization signal Si and the image signal Di output from the image signal receiving device 22 are input to the frame selection device 26 and the index discriminating device 23 shown in FIG. 2. The index discriminating device 23 computes the position within the image signal, of the transmission index signal which is constituted by the light and shade of the pixel shown in FIG. 5, with the synchronization signal Si as a reference for the timing (datum reference on the time axis), and extracts the received transmission index signal.

The transmission index signal, from a noise tolerance point of view, is more simply expressed by a combination of gradations of the maximum value or the minimum value of half-toning (that is, the 255th gradation or the 0th gradation in 256 half-toning). In the following description, for simplicity, the transmission index signal is constituted by combining the maximum values or the minimum values of the half-toning.

The received transmission index signal, is binarized in the index discriminating device 23 based on a previously set threshold value. As one example of this threshold value, the 128th gradation being the gradation of half the 256 gradations is adopted as the threshold value. In this case, for example this is applied as a flag which becomes “1” when the gradations are from 255 gradations to 129 gradations, and becomes “0” when the gradations are from 0 gradations to 128 gradations, and the index ID is constructed by combining these flags.

The index discriminating device 23 outputs the index ID obtained in the abovementioned manner to the index judgment device 25. On the other hand, the image display apparatus number/position setting device 24 outputs the plurality of image display apparatus numbers N previously set for its own device to the index judgment device 25. In these image display apparatus numbers N, for example a plurality of combinations of “1” or “0” are set by hardware settable dip switches.

Moreover, in the index discriminating device 23, an image display apparatus number set using on screen display (hereafter called OSD) can be stored using a device for storing settings such as a microcomputer (hereafter called a MPU), and the image display apparatus number N output.

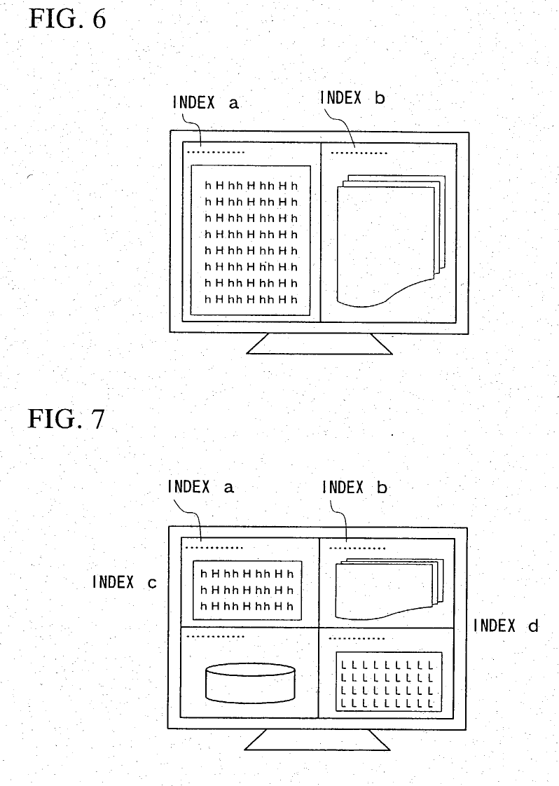

Furthermore, the image display apparatus number/position setting device 24 outputs image display positions Np set for each of the plurality of image display apparatus numbers which have been previously set in its own device, to the image compression device 27 and the image storage device 28. For these image display positions Np, for example in the case where two image display apparatus numbers N are specified, as shown in the image display apparatus of FIG. 6, specification is performed to display on the left side in the case where the index ID contained in the image frame is “a”, and on the right side in the case where the index ID contained in the image frame is “b”. Here, the position of the image display apparatus may be in a vertical direction.

Moreover, for example as shown in FIG. 7, in the case where four image display apparatus numbers are set, respective positions of top left, bottom left, top right and bottom right are given for the frames containing the four transmission index signals of a, b, c and d. In this screen separation method, for example the frames may be sequentially lined up in the transverse direction, and the alignment direction may be arbitrarily set beforehand. For these image display positions Np, for example combinations of “1” or “0” are set by hardware settable dipswitches. Moreover, by means of the method using the MPU as mentioned above, storage and output is also possible for the image display positions Np.

Hereunder, to simplify explanation, is a description for the case of two image display apparatus numbers. However the operation is the same for the case where this is set to three or more.

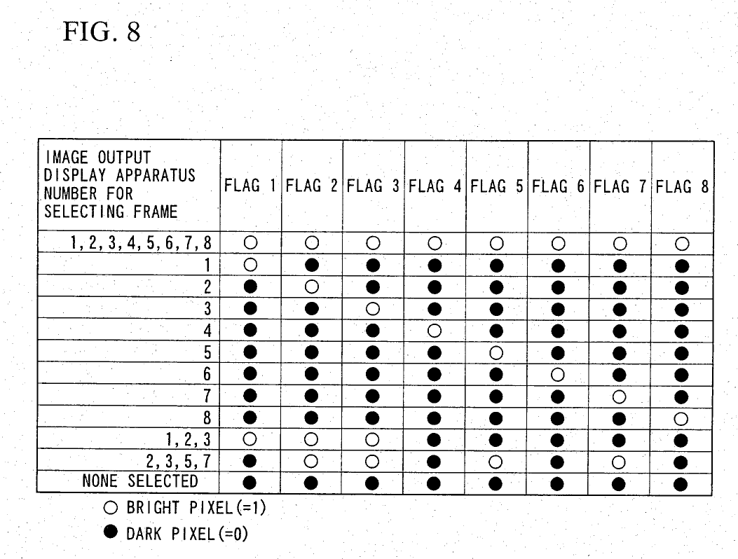

The index judgment device 25 outputs the frame selection signal FS based on the discriminated index ID and the image display apparatus number N. FIG. 8 shows the relationship of the index ID expressed by the flags and the image display apparatus number for selecting the frame. In FIG. 8, the white circles show the flags corresponding to bright pixels, and the black circles show the flags corresponding to dark pixels. As described above, an 8 bit flag is generated by binarizing the transmission index signal in the index discriminating device 23 (that is, corresponding to the transmission index signal shown in FIG. 5). Here since the index ID comprises an 8 bit flag, then at maximum the case of 256 (display modes) can be specified. In this case, the number of numbers for the controllable image display apparatus coincides with the number of bits of the index ID.

As will be understood with reference to FIG. 8, in the case where all of the flags are “1”, then in both image display apparatuses 13 and 14, a frame having a transmission index signal such that all of the flags become “1” is selected. That is, in all cases no matter how the picture output device number is set, a image signal for the selected frame is output. Therefore, in the image display apparatus 13 having a plurality of image display apparatus numbers as with the present invention, the same picture is multiply displayed.

Moreover, in the case where the flag 1 is “1”, then in the case where a “1” is set for the image display apparatus number N, a frame such that the flag generated from the transmission index signal becomes “1” is selected, while in the case where the flag 2 is “1”, a frame such that the flag 2 generated from the transmission index signal in the case where a “2” is set for the image display apparatus number N becomes “1”, is selected. In this manner, in the case where the mth flag in the index ID is “1”, a frame such that the mth flag generated from the transmission index signal in the image display apparatus 12 with an “m” set for the image display apparatus number N becomes “1”, is selected.

At this time, there may be a plurality of picture output apparatuses with m set for the picture output apparatus number N. Furthermore, by having a certain frame such that a plurality of flags for the frame become “1”, it is also possible to select frames in a plurality of picture output apparatuses set with a different image display apparatus numbers N. Moreover, in the case where there are two or more image display apparatus numbers N set for the image display apparatus 13, it is also possible to specify the same number. In this case, obviously the same picture will be displayed at the position specified by the same numbers.

The frame selection device 26 selects a predetermined frame from the input image signal Di, based on the frame selection signal FS which the index judgment device 25 has output. Here since the transmission index signal is substituted for one part of the image period, then the actually selected frame is the frame after one frame. The image signal Ds selected by the frame selection device 26 is output to the image compression device 27 shown in FIG. 2. The image compression device 27 compresses the image signal Ds which the frame selection device 26 has selected, based on the image display position Np output by the image display apparatus number/position setting device 24.

In this image compression, for example two image display apparatus numbers are set, and in the setting where the picture is arranged horizontally, the horizontal direction is compressed by 1/2. For this compression, simply a technique for averaging the adjacent dots may be used. However in order to maintain the picture image, a compression technique using a spatial filter, or an advanced technique such as cubic convolution may be used. Furthermore, in the setting where the images are arranged in the vertical direction, a vertical direction data comparison is performed, however basically this is the same as for the case of the horizontal direction.

The image signal Dm compressed by the image compression device 27 is output to the image storage device 28 shown in FIG. 2. The image storage device 28 stores the image signal Dm which the frame selection device 26 has selected and which has been compressed by the image compression device 27, in a memory region corresponding to the picture position indicated by the image display position Np set in the image display apparatus number/position setting device 24. Here the memory of the image storage device 28 is one having a memory region for one or more pictures, and provided renewal is not performed, previously written data is held and stored. Therefore previous data remains in the memory region other than the picture region in which the image signal Dm is written.

In the memory region where writing has not been performed at this time, for example a compression image for the frame containing the transmission index signal to be displayed is stored in the last received region, and this image and the image which has been written, are combined to construct one image, and then output to the image display device 29 as the image signal Dr.

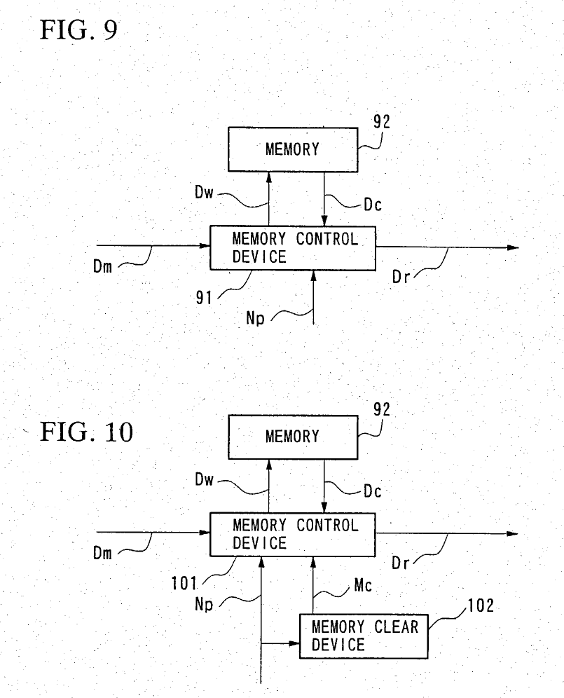

Next is a description of the basic construction of the image storage device 28 using the block diagram of the image storage device of FIG. 9. In FIG. 9, the image storage device 28 comprises a memory control device 91 and a memory 92. Dw is a write image signal containing a memory write address output from the memory control device 91, while Dc is a image signal which is read out from the memory 92. Dm, Dr and Np are as described for FIG. 2.

The memory control device 91 receives the image signal Dm input from the image compression device 27, and appends a picture write address determined based on the image display position Np input by the image display apparatus number/position setting device 24, and outputs the write image signal Dw. The memory 92 stores the image signal in accordance with the write address contained in the write image signal Dw. At this time, data for addresses which are not specified is held as is.

The memory control device 91 reads out the data from the memory 92, matching the format of the signal output to the image display device 29, and outputs this as the image signal Dr. The image display device 29 receives the image signal Dr output by the image storage device 28 and displays this. In the above description, the case was described where the transmission index signal was substituted for the image signal in a period within the image period. However the construction of other transmission index signals is as shown in Japanese Unexamined Patent Application, First Publication No. 2000-352962, and description is here omitted.

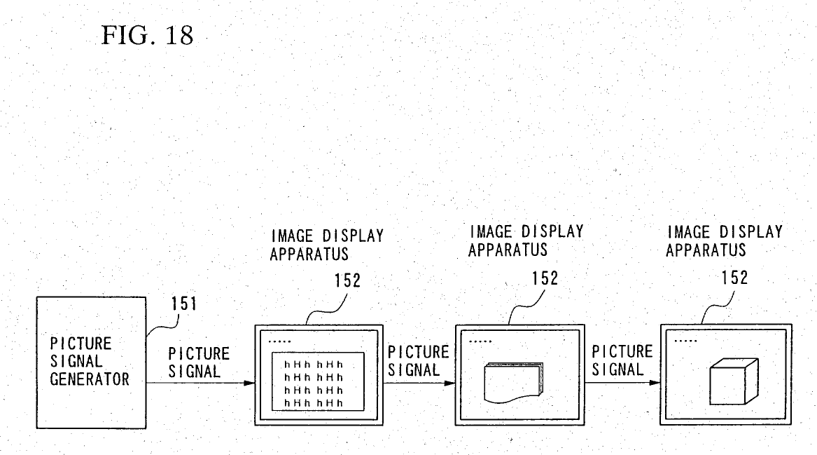

Furthermore, in the above described example, the case where the image display apparatuses were connected in parallel was described. However, as shown in FIG. 18, by providing a image signal output device in the above configuration, the image display apparatuses 13 can also be multiply connected in series. The differences between the configuration and operation for this case and the configuration and operation as mentioned above are described in detail in Japanese Unexamined Patent Application, First Publication No. 2000-352962, and description is omitted here.

Second Embodiment

FIG. 10 is a block diagram showing a configuration of an image storage device 28 in a second embodiment of the present invention. The image storage device 28 comprises a memory 92, a memory control device 101 and a memory clear device 102. Mc indicates a memory clear signal. Next is a description of the operation of the second embodiment, with reference to FIG. 10. The memory clear device 102, at the time of power supply start up of the image display apparatus 13, or in the case of user intention, creates and outputs a memory clear signal Mc for clearing the memory. At this time, at the time of power supply start up or the like, the whole screen is cleared, however in the case of intention by the user, it is also possible to clear only the picture data which contains a specific transmission index signal. In this case, a picture clear signal corresponding to the image display position Np is created. For the setting of the picture clear, more simply, there is a method of setting by combinations of dip switches or the like. Moreover, it is also possible to perform setting of the picture clear using the MPU and the OSD. In this case, it is also possible to achieve clearing of the picture at a timing which is previously programmed.

In the memory control device 101, the image signal Dm input corresponding to the memory clear signal Mc input from the memory clear device 102 is cleared, and the cleared data is output as Dw. As a result, null data is written to the memory 92, and when the memory control device 101 reads out, this is read out as a black signal. In the memory control device 101, with each clear operation, not only is the null data written in, but previously set RGB data may be written in. In this case, by displaying a specified color in the cleared image frame, then for example in the case where R=“0”, G=“0” and B=“255” is specified, this gives a blue picture. Furthermore, not only can just a single color be written in as described above, but it is also possible to write in specific pattern information. For example, characters such as “cleared” may be displayed.

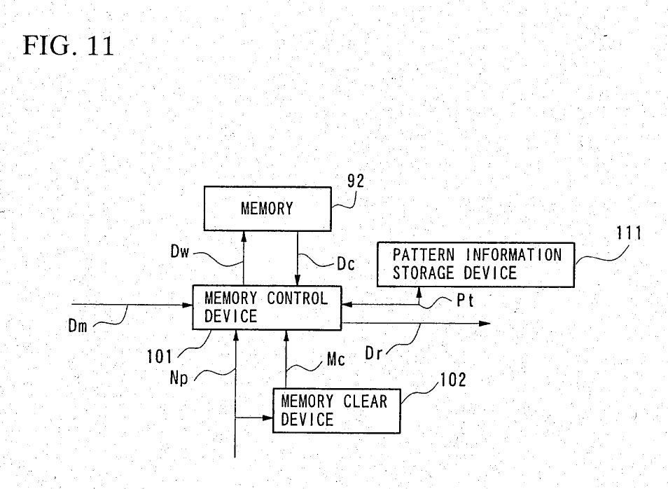

The configuration of the image storage device for the case of writing in pattern information is shown in FIG. 11. In FIG. 11, for this image storage device 28, in addition to the memory 92, the memory control device 101 and the memory clear device 102, there is added a pattern information storage device 111 for storing pattern information. Pt denotes pattern information. Here the pattern information storage device 111 uses a normal non volatile memory, so that data once written is retained even if the power supply is switched off. However a non volatile memory may be used and information written in from outside as required.

Describing the operation using FIG. 11, when the memory control device 101 receives the memory clear signal Mc from the memory clear device 102, the memory control device 101 reads out the pattern information Pt from the pattern information storage device 111, substitutes the pattern information Pt for the input image signal Dm, which is input to the memory control device 101, and outputs it as the image signal Dw. Other operation than this is the same as described above, and hence description thereof is omitted.

By having the above described configuration, then for example in the period from start up of the power supply until the transmission index signal to be displayed is received, display of an abnormal screen due to irregular signals can be prevented. Moreover, even in the case where the user desires to delete the display screen, specific pages only can be deleted. Furthermore, by displaying a specific pattern accompanying clearing of the screen to show it has been cleared, it can be discriminated if there is a null signal or a clear screen. By means of such an operation, it is possible to avoid displaying a picture which may be disagreeable to the user. Moreover, since selection of display/non display of an image can be performed, depending on the content of an applied scene, it is possible to provide an image display apparatus which can give high usage with an even greater degree of freedom.

Third Embodiment

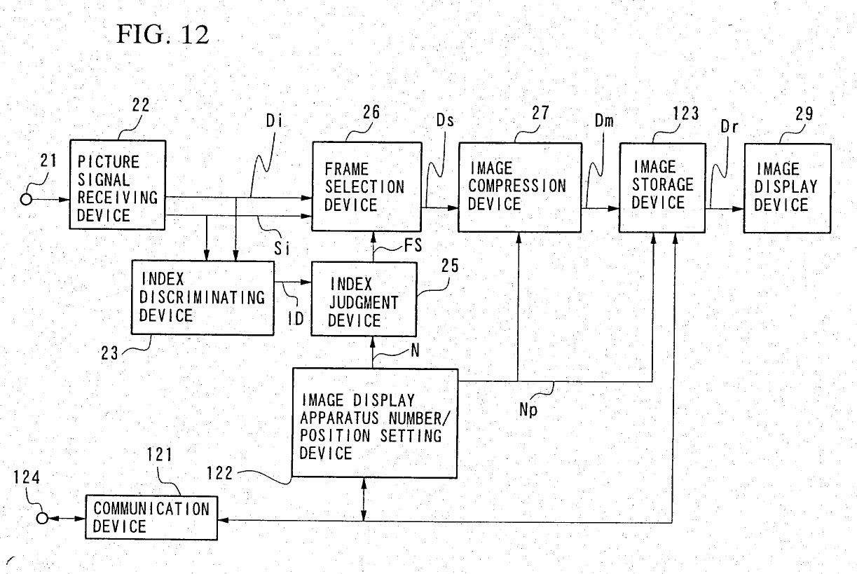

FIG. 12 is a block diagram showing the configuration of an image display apparatus 13 according to a third embodiment of the present invention. In FIG. 12 the image display apparatus 13 comprises; a image signal input terminal 21, a image signal receiving device 22, an index discriminating device 23, an image display apparatus number/position setting device 122, an index judgment device 25, a frame selection device 26, an image compression device 27, an image storage device 123, an image display device 29, and a communication device 121. Since for the image display apparatus number/position setting device 122 and the image storage device 123, the signal input/output functions are different to the first embodiment shown in FIG. 2, their reference symbols are changed. Furthermore, 124 denotes a connection terminal for the communication device 121. Hereunder description is omitted for parts which duplicate those of the first embodiment.

In the description of the operation according to the configuration as described up until now, the image display apparatus number N and the image display position Np of the image display apparatus 13 are set to arbitrary values by the image display apparatus number/position setting device 24. Moreover, the clear timing of the memory clear device 102 in FIG. 10 described for the abovementioned second embodiment, is also set so as to be performed at an arbitrary timing.

On the other hand, the operation of the third embodiment is as follows. The communication device 121 is connected to the image signal generator 11 (FIG. 1) via the connection terminal 124. For this connection, usually an electrical connection device such as a connection cable is used. Generally, the image signal generator 11 uses a personal computer (PC) or the like, and for the communication method it is assumed that a two way communication interface such as a USB or a DDC-CI is used. In this two way communication, the image display apparatuses connected in parallel can be controlled by connection in parallel from a PC.

The image signal generating device 12 verifies by communicating the number of image display apparatuses which are connected, and the number of image display apparatus numbers which are set for each of these image display apparatuses, and outputs an image display apparatus number which is to be set, to the respective image display apparatuses. Furthermore, the positions to be displayed for each of the numbers are also output to the image display apparatus in which the image display apparatus numbers are multiply set. Moreover, the image signal generating device 12 learns the number of the connected image display apparatus numbers to thereby automatically set the number of pages held thereinside.

By means of the above mentioned configuration, it is no longer necessary for the user to set the image display apparatus number each time the display apparatus is used, so that convenience is improved, and deterioration in working efficiency due to erroneous setting such as when setting of the number of pages can be avoided. Moreover, in the case where sequential connection of the image display apparatuses 152 is used such as shown in FIG. 18 for the conventional technology, then a configuration in relation to the communication device 121 where adjacent image display apparatuses 152 are sequentially connected, can also be applied. In such a configuration, communication is possible between the image display apparatuses 152, and the sequentially connected image display apparatus numbers can be set without using the setting by means of the image signal generator 11.

Furthermore, in the above described connection, by also connecting the image storage device 123 to the communication device 121 as shown in FIG. 12, it is possible to set the timing for clearing the picture as illustrated by the second embodiment of the present invention, from the image signal generator. As a result, it is possible to ensure that abnormal signals which occur for example at the time of a change in the image signal are not displayed, so that an image display apparatus which does not give a disagreeable sensation to the user can be provided.

Fourth Embodiment

In the description of the operation and configuration of the abovementioned third embodiment, a volatile memory was used for the memory 92 used in the image storage device 123. However a non volatile memory can also be adopted for this memory. In a non volatile memory, even if the power supply is switched off, the contents of the memory are retained. Therefore provided that the contents data are not again rewritten, the last displayed contents can be continuously stored on the image display apparatuses 13 and 14.

According to the fourth embodiment, if the user once displays different images on each of a plurality of image display apparatuses, a desired image can be displayed on the image display apparatus even if subsequently, the image signal generator disappears, and for example a highly convenient image display apparatus can be provided for a store front display or the like.

Fifth Embodiment

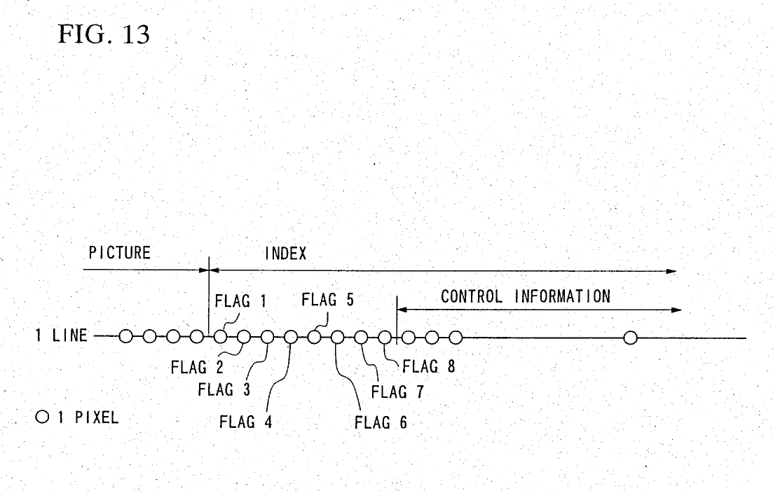

In Japanese Unexamined Patent Application, First Publication No. 2000-352962 of the conventional technology, a configuration for the transmission index signal where this contains information for controlling the image display apparatus is proposed. In a fifth embodiment, to the control information proposed by the above mentioned conventional technology, there is further added information of the image display apparatus number and the image display position. FIG. 13 is a conceptual diagram showing flags for one part of one line of a image signal, for the case where a transmission index signal of the fifth embodiment is substituted for one part of the image signal.

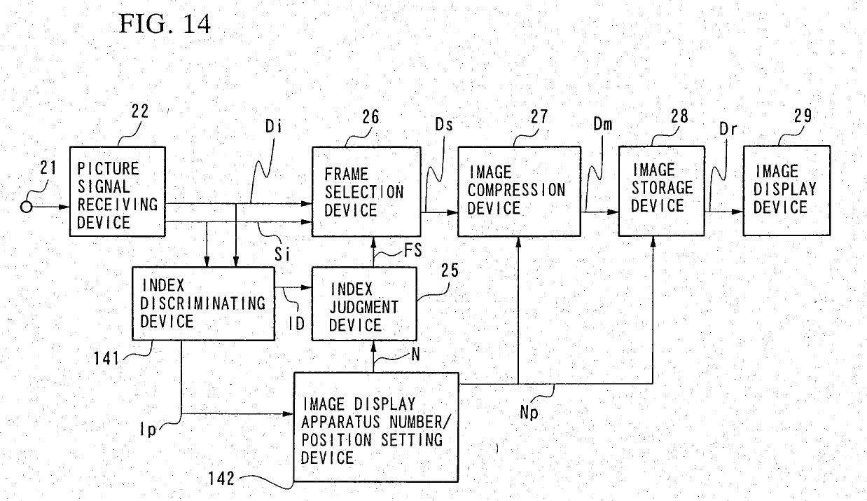

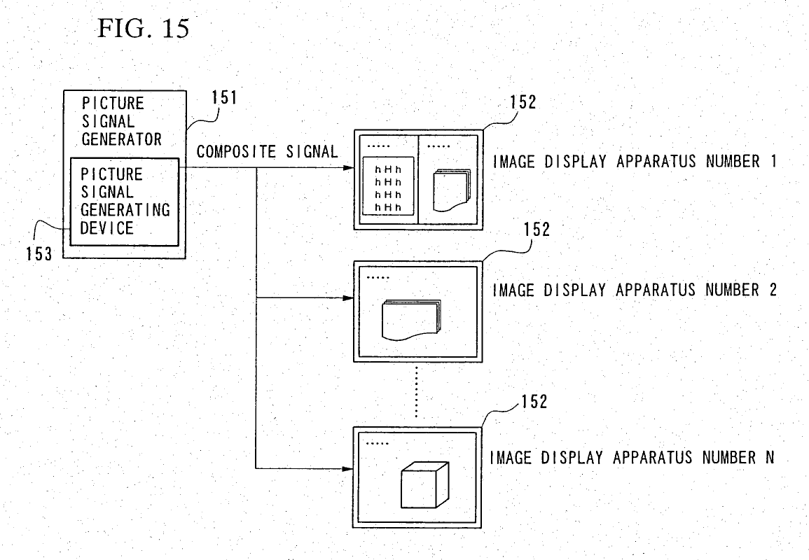

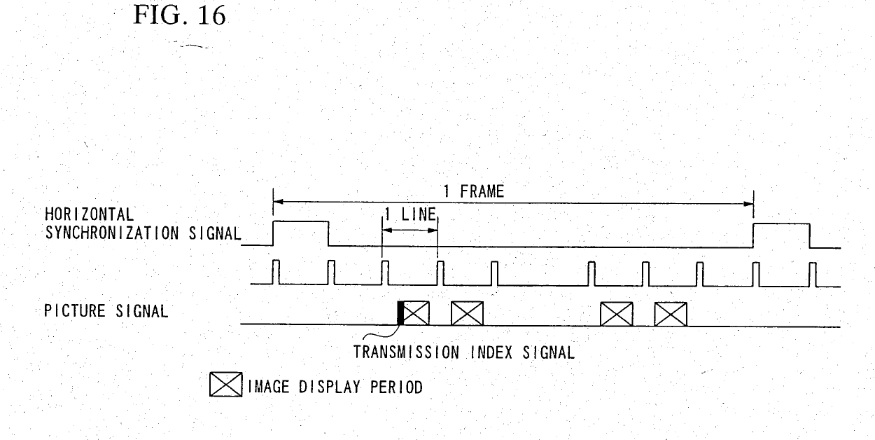

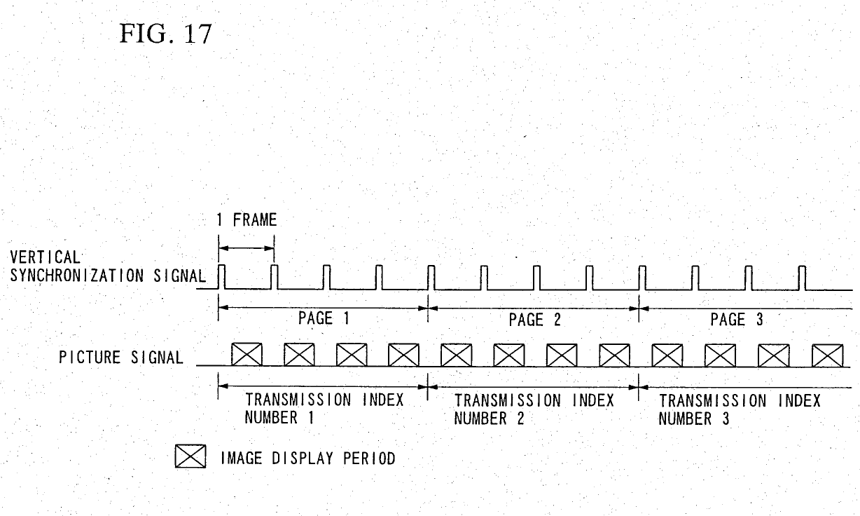

FIG. 14 is a block diagram showing the configuration of an image display apparatus 13 according to the fifth embodiment. In FIG. 14, the image display apparatus 13 comprises a image signal input terminal 21, a image signal receiving device 22, an index discriminating device 141, an image display apparatus number/position setting device 142, an index judgment device 25, a frame selection device 26, an image compression device 27, an image storage device 28, and an image display device 29. Since for the index discriminating device 141 and the image display apparatus number/position setting device 142, the signal input/output functions are different to the first embodiment shown in FIG. 2, their reference symbols are changed. Hereunder description is omitted for parts which duplicate those of the first embodiment. Furthermore Ip is control information which is output from the index discriminating device 141.

Hereunder is a description of the operation of the fifth embodiment using FIG. 14. The index discriminating device 141 receives a image signal Di and a synchronization signal Si after the image signal output from the image signal generator 11 has been digitally encoded by the image signal receiving device 22. Furthermore, the index discriminating device 141 extracts the transmission index signal from the image signal Di with the received synchronization signal Si as a reference, and then separates the extracted transmission index signal into an index flag and control signal, and outputs the information for the image display apparatus number and the image display position contained in the control signal as the control information Ip, to the image display apparatus number/position setting device 142.

The image display apparatus number/position setting device 142 updates the image display apparatus number of its own device based on the received control information Ip and outputs an image display apparatus number N. Similarly, also for the image display position, this is updated based on the received control information Ip, and then output as the image display position Np. For the other operations, since these are the same as described for the first embodiment, description is here omitted.

According to the fifth embodiment, communication from the image signal generator 11 to the image display apparatus 13 can be achieved without providing a separate communication device, and by means of this communication the image display apparatus number and the image display position can be controlled. Therefore operations such as automatically performing setting changes of a desired image without a user changing the setting of the image display apparatus itself become possible.

1. An image display apparatus for receiving a image signal having a predetermined format and displaying said image signal, comprising:
a image signal receiving section which receives a composite signal containing a image signal comprising a plurality of image frames, a synchronization signal corresponding to said image signal, and a transmission index signal substituted for one part of said image signal, and outputs said image signal and said synchronization signal;
an image frame selection section which multiply selects image frames to be displayed on its own device from said plurality of image frames, based on the transmission index signal output from said image signal receiving section, and simultaneously outputs a plurality of image signals corresponding to the selected plurality of image frames; and
an image display section which displays a image signal corresponding to the plurality of image frames output from said image frame selection section.

2. An image display apparatus according to claim 1, wherein said image frame selection section comprises:
an index discriminating device which discriminates a transmission index signal contained in either of an image display period and a picture non-display period in an image frame, based on the image signal and the synchronization signal output from said image signal receiving section;
an image display apparatus number/position setting device which outputs a plurality of image display apparatus numbers set with respect to its own device, and image display positions corresponding to these;
an index judgment device which outputs a frame selection signal for selecting an image frame contained in a image signal, based on an index signal output by said index discriminating device and an image display apparatus number of its own device output by said image display apparatus number/position setting device;
a frame selection device which selects an image frame contained in said image signal corresponding to a frame selection signal output from said index judgment device;
an image compression device which compresses a image signal corresponding to an image frame output from said frame selection device, based on a set image display apparatus number; and
an image storage device which stores a compressed image signal output from said image compression device in accordance with an image display position output by said image display apparatus number/position setting device.

3. An image display apparatus according to claim 2, wherein said image frame selection section further comprises a clearing device which clears information stored in said image storage device.

4. An image display apparatus according to either one of claim 2 and claim 3, wherein said image frame selection section further comprises a communication device which communicatively connects said image display apparatus number/position setting device and said image storage device.

5. A control method for an image display apparatus for receiving a image signal having a predetermined format and displaying said image signal on an image display apparatus, comprising the steps of; controlling an image display apparatus number and an image display position based on a control signal contained in a transmission index signal, and displaying a desired image on said image display apparatus.
